(19) United States
(12) Patent Application Publication
(10) Pub. No.: US 2007/0124405 A1
(43) Pub. Date: May 31, 2007

(54) Chat detection

(76) Inventors: Cedric S.P. Ulmer, Nice (FR); Cédric R.J. Hébert, Mouans Sartoux (FR); Laurent L.Y. Gomez, Le Cannet (FR); Olivier B. Dumas, Nice (FR); Emmanuel A.A. Savy, Nice (FR); Jeremie R.A. Clergue, Onex (CH)

Correspondence Address: PERKINS COIE LLP, 101 JEFFERSON DR, PO BOX 2168, MENLO PARK, CA, 94025, US

(21) Appl. No.: 10/547,735

(22) PCT Filed: Dec. 27, 2004
(86) PCT No.: PCT/IB04/04274

§ 371 Date: Aug. 31, 2005

(51) Int. Cl. G06F 15/16

(52) U.S. Cl. 709/207

(57) ABSTRACT

A method, system and apparatus for chat detection is provided. In one embodiment, the invention is a method. The method includes detecting a series of related emails. The method also includes querying a first user to determine if the first user desires to switch to a chat. The method further includes querying a second user to determine if the second user desires to switch to a chat. Moreover, the method includes initiating a chat between the first user and the second user. The method may also include detecting an end of a chat, and may similarly include providing a log of the chat.

### CROSS-REFERENCE TO RELATED APPLICATION

None

### FIELD

The present invention, in various embodiments, generally relates to email software and more specifically to interaction between email and peer-to-peer or instant messaging software.

### BACKGROUND

In general, email is a useful tool for business and personal communications. It allows for editing of communications, relatively quick communication, and viewing or reply at the time and place chosen by the recipient. With the expansion of the internet and world wide web, email has become a ubiquitous and necessary part of business, and a significant part of personal lives as well. For e-commerce, email is a vital part of the process in many instances, such as through use of confirming emails for purchases of goods or advertisement of offered goods and services.

Similarly, for internal business purposes, email communication can be vital. Executives can send emails to subordinates and get quick or immediate responses with up-to-date information. Similarly, team members can discuss matters via email, providing both a forum for communication about various issues and a log of what was said. In particular, the log of comments can be useful to retrieve ideas initially not chosen which may later be reconsidered.

Unfortunately, email also provides a number of disadvantages. For example, a steady stream of emails arriving in drip-like fashion can distract from other productive work employees may be expected to perform. Likewise, a conversation carried out over email may be disjointed, subject to interruption due to delays in email transmission, similarly interrupted due to a user not noticing a reply email, and otherwise difficult to use for purposes of a close to real-time communication. Email also produces issues in terms of use of bandwidth (email can have large overhead for example), and use of storage media resources—all of the email messages must be stored somewhere, and must also be stored multiple times in store-and-forward networks. Thus, the email servers may be overloaded by the emails used to achieve something approaching real-time communication.

Other tools are available for real-time communication. Telephone conversations still work, even in the age of the internet. However, telephone conversations require coordination and accessibility of at least one person at a telephone number known to the other person. Instant messaging or peer-to-peer communication can also be used. However, initiation of such communication requires that the two participants already be present on the system before communication may begin. Thus, a telephone call or email must be sent to get a person who is not on a system into such a discussion, for example.

### SUMMARY

A method, system and apparatus for chat detection is provided. In one embodiment, the invention is a method. The method includes detecting a series of related emails. The method also includes querying a first user to determine if the first user desires to switch to a chat. The method further includes querying a second user to determine if the second user desires to switch to a chat. Moreover, the method includes initiating a chat between the first user and the second user.

In another embodiment, the invention is a system. The system includes a processor, a memory, a user interface, and a network interface. The system further includes a chat detector module. The system also includes an instant messaging module. Each of the memory, user interface, network interface, chat detector module and instant messaging module are coupled to the processor.

In yet another embodiment, the invention is a method. The method include detecting related emails exceeding a predetermined threshold. The method also includes initiating an instant message chat between senders of the emails.

Methods of the embodiments may be performed by a processor responsive to execution by the processor of a set of instructions, with the instructions embodied in a machine-readable medium. The invention may also be a machine-readable medium embodying instructions, which, when executed by a processor, cause the processor to perform the method, in some embodiments.

It will be appreciated that the present invention is described below using specific examples that are not intended to limit the invention. The systems and methodology may be applied to a broad range of other computer applications. Therefore these and other advantages and aspects of the present invention will become apparent to those skilled in the art upon a reading of the following detailed description and a study of the drawing figures.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 illustrates an embodiment of a method of converting from an email discussion to a chat.

FIG. 2 illustrates another embodiment of a method of converting from an email discussion to a chat and ending the chat.

FIG. 3A illustrates an embodiment of a mail system supporting an email communication.

FIG. 3B illustrates an embodiment of a mail system supporting a chat.

FIG. 4A illustrates an embodiment of a client.

FIG. 4B illustrates an alternate embodiment of a client.

FIG. 4C illustrates another embodiment of a client.

FIG. 5A illustrates an embodiment of a method of detecting an email conversation.

FIG. 5B illustrates an embodiment of a method of switching from an email conversation to a chat.

FIG. 6 illustrates another embodiment of a method of switching from email to chat operation.

FIG. 7 illustrates an embodiment of a network or system which may be used for email and/or chat data transmission.

FIG. 8 illustrates an embodiment of a machine or system which may embody or include a client useful for email and/or chat operation.

FIG. 9 illustrates another embodiment of a client.

### DETAILED DESCRIPTION

A method, system and apparatus for chat detection is provided. A chat may be detected when a series of related emails between two users is detected. The users may then be offered the option to switch from communication by email to communication by chat (e.g. instant messaging or peer-to-peer communication). Such communication may then occur between the two users. At the end of the communication a user may be offered a log or summary of the communication as well. Thus, communication may be facilitated without using email resources, while a log of the communication may also be provided for later reference.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In one embodiment, the invention is a method. The method includes detecting a series of related emails. The method also includes querying a first user to determine if the first user desires to switch to a chat. The method farther includes querying a second user to determine if the second user desires to switch to a chat. Moreover, the method includes initiating a chat between the first user and the second user.

The method may also include querying the first user and the second user about providing a log of the chat between the first user and the second user. The method may further include providing the log of the chat between the first user and the second user. Also, the method may include querying the first user about whether a summary of the instant message chat is desired. Moreover, the method may include receiving a user summary from the first user. Additionally, the method may include prompting the first user to provide a user summary.

In another embodiment, the invention is a system. The system includes a processor, a memory, a user interface, and a network interface. The system further includes a chat detector module. The system also includes an instant messaging module. Each of the memory, user interface, network interface, chat detector module and instant messaging module are coupled to the processor.

The system may further include means for querying a user to allow the user to request a summary. The system may also include an email server. The system may include a first user computer and a second user computer.

In yet another embodiment, the invention is a method. The method include detecting related emails exceeding a predetermined threshold. The method also includes initiating an instant message chat between senders of the emails.

Furthermore, the method may include querying a first sender of the related emails about whether to initiate the instant message chat. Moreover, the method may include querying a second sender of the related emails about whether to initiate the instant message chat. Additionally, the method may include initiating the instant message chat includes querying a first sender of the related emails and a second sender of the related emails. The method may also include providing a log of the instant message chat. The method may further include querying a first sender of related emails as to whether the log is desired. The method may also include querying a first sender of the related emails as to whether a summary of the instant message chat is desired. The method may involve receiving a user summary from the first sender. Similarly, the method may include prompting the first sender to provide the user summary responsive to a user response to the querying for a summary.

Additionally, the methods of the embodiments may be performed by a processor executing a set of instructions, the set of instructions embodied in a machine-readable medium. Similarly, systems may embody a set of instructions in a machine-readable medium, which cause a general-purpose machine or computer to operate as a specific system when executing the set of instructions.

While the invention may be embodied in a variety of ways, a method may be instructive as to how conversion from email to peer-to-peer or chat operation may occur.

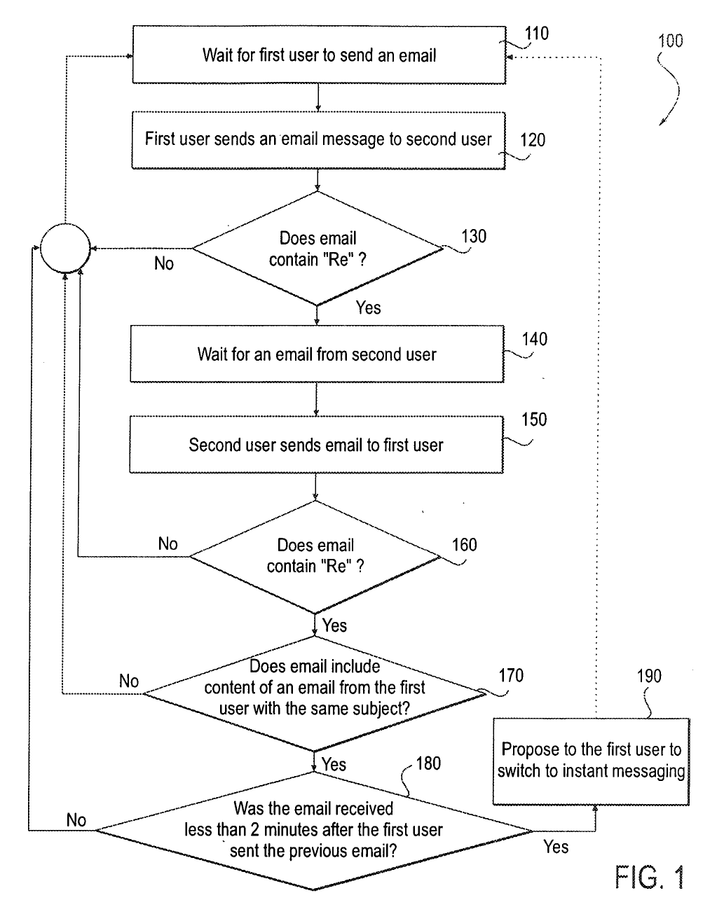

FIG. 1 illustrates an embodiment of a method of converting from an email discussion to a chat. Method 100 includes waiting for an email to be sent, detecting the first email as part of a series of messages, waiting for a second email to be sent, detecting the second email as part of the series of messages, determining a time threshold for succeeding messages has not been exceeded, and offering a switch to chat or instant messaging.

Method 100 and all methods described in this document include a series of modules, which may be rearranged into a series or parallel format for execution, for example. Moreover, such modules may be subdivided or combined in ways apparent to those of skill in the art. Similarly, such modules may be implemented in a variety of ways, such as method operations, code (software) modules, or hardware modules operating as described, for example.

At module 110, the method waits for a first user to send an email message. At module 120, the first user sends the email message to a second user. At module 130, a determination is made as to whether the email includes a “Re:” subject (for example). If not, monitoring begins again at module 110.

If so, monitoring of the second user occurs at module 140 (which may be understood as looping on itself until an email is sent for example). At module 150, the second user sends an email to the first user. Again, a determination is made as to whether the email includes a “Re:” subject or similar indication of a reply at module 160. If not, the process returns to monitoring at module 110.

If so, a determination is made at module 170 as to whether the email sent by the second user includes content from the first user. If not, the process returns to monitoring at module 110. If so, at module 180, a determination is made as to whether a time threshold for successive messages has been exceeded, such as both the first and second messages being sent within two minutes, for example. If not (messages were too far apart in time), the process returns to monitoring at module 110. If so (messages were close in time), a switch to instant messaging is proposed at module 190.

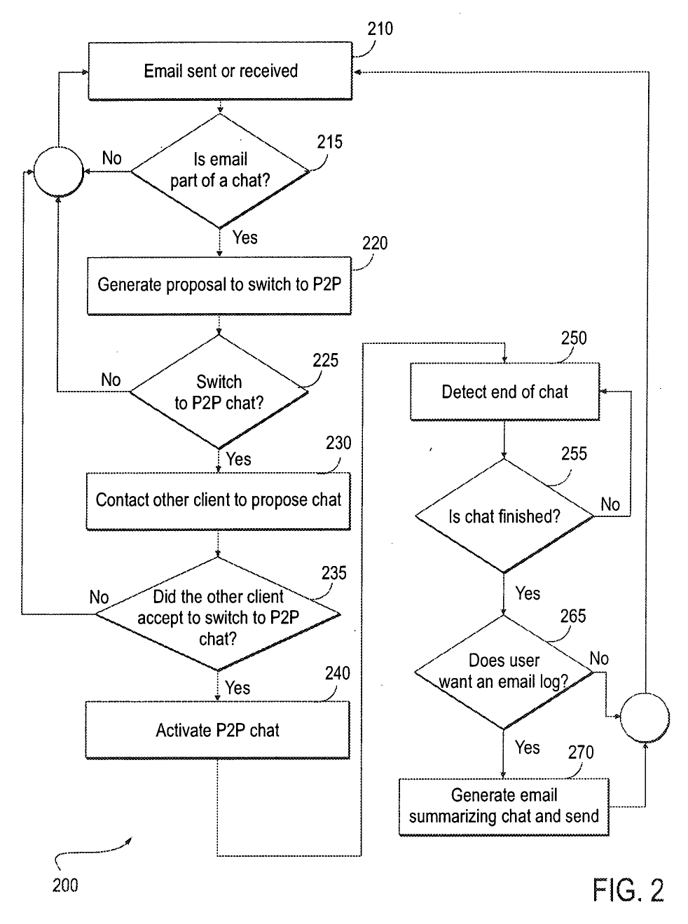

Actual switches from email to chat may be accomplished in a variety of ways. Thus, the process of FIG. 1 may be involved with various processes for initiation of a chat session. FIG. 2 illustrates another embodiment of a method of converting from an email discussion to a chat. At module 210, an email is sent or received. At module 215, a determination is made as to whether the email is part of a chat—a series of related emails received relatively close in time. If not, the process waits at module 210 for another email.

If so, a proposal to switch to peer-to-peer or chat communication is presented to the user of the email at module 220. At module 225, a determination is made as to whether the user wishes to switch to a chat. If not, the process waits at module 210 for another email. If so, at module 230, the client for the other potential user in the chat is contacted, allowing for querying of that user about switching to chat operation. A determination is made as to whether the other client (and thus the other potential user) accepted the proposal to switch to chat operation at module 235. If not, the process waits at module 210 for another email.

If so, at module 240, the proposed chat is activated, such as through an instant messaging or similar peer-to-peer client, and communication commences. At module 250, the process listens for an end to the chat (such as by a user ending the chat for example). At module 255, a determination is made as to whether the chat ended. If not, listening continues at module 250. If so, a determination is made at module 265 as to whether the user wants a log of the chat (such as by querying the user). If so, a summary or log is generated (and may be emailed or otherwise provided) at module 270. If not, or after the log is generated, the process returns to module 210 to wait for further emails.

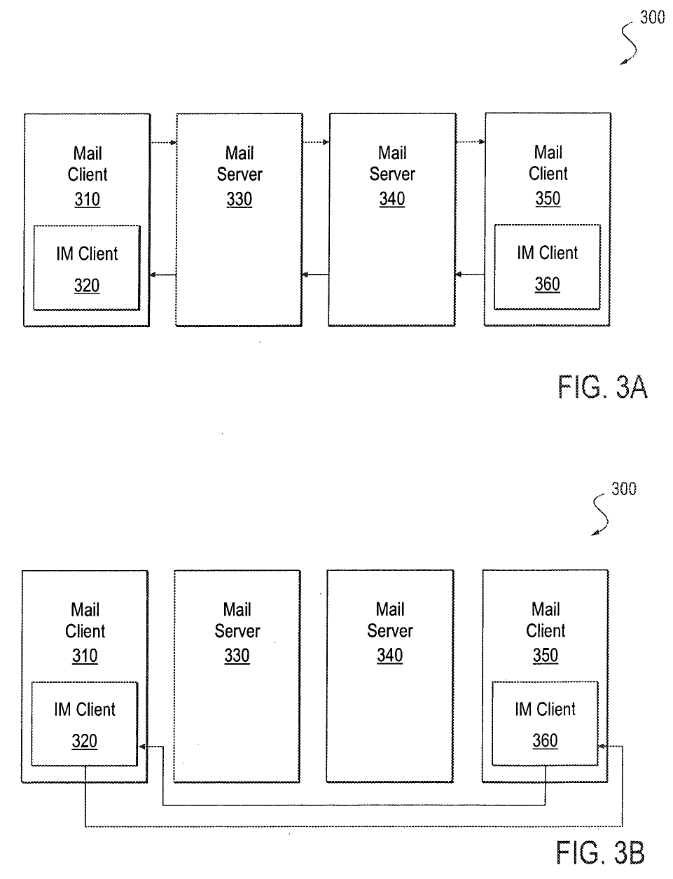

A system operating email and instant messaging (and switching between the two) may be expected to take on various forms which may be used with the methods of FIGS. 1 and 2, and other methods of the invention. FIG. 3A illustrates an embodiment of a mail system supporting an email communication. System 300 includes a mail client with an IM (instant messaging) client, a mail server, another mail server, and another mail client with an IM client, allowing for both email and IM communication.

System 300 includes mail client 310 with embedded IM client 320. Thus, mail client 310 is capable of email communication, but may also operate with IM communication (using IM client 320) as appropriate. For mail communications, a message is sent on to a local mail server 330 which is coupled to mail client 310. The message is then sent to another local mail server 340 (such as through a local network or the internet for example). The message is finally sent to another mail client 350, which is coupled to server 340 and is used by a recipient of the message. The local mail client also has an embedded IM client 360.

Thus, the recipient may read the message, and may respond. A responsive message is generated at mail client 350. The responsive message is then sent to local mail server 340. From there, the message goes to local mail server 330 and then to mail client 310. Thus, a round trip may require resources or four different machines (or resources of four different parts of a large system for example) and much routing information must be included to make sure the message goes to the right place. Moreover, congestion on intervening network connections or couplings may delay one or both messages, or stop delivery altogether.

The system 300, as illustrated, may also support chat operation. FIG. 3B illustrates an embodiment of a mail system supporting a chat. Once the chat operation is commenced, the communications occur between IM clients 320 and 360 (each of which are embedded in mail clients 310 and 350). An IM server (not shown) may also be involved, but the mail servers may be expected to not be involved in chat operations, thus freeing the mail servers for email which is not suitable for peer-to-peer communication.

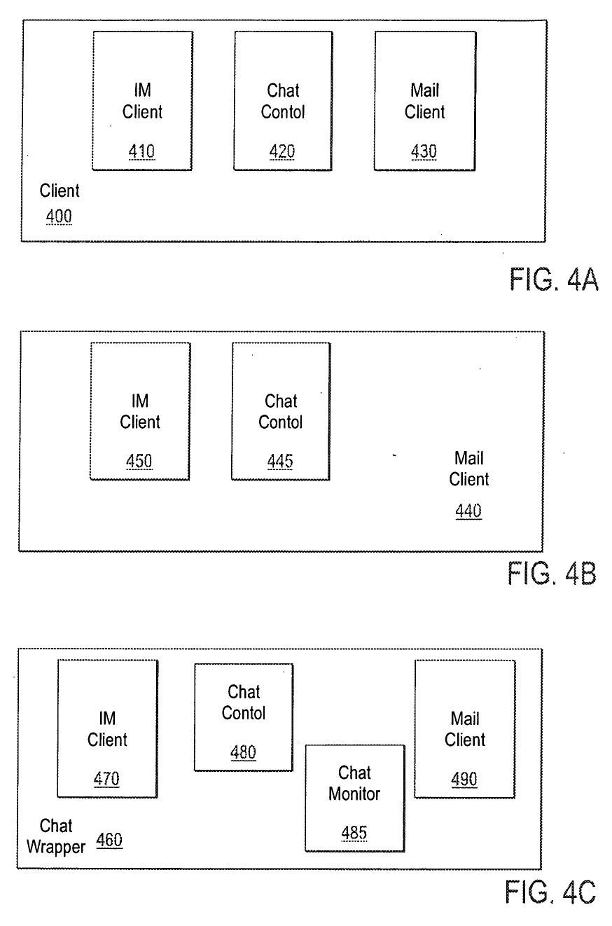

Various clients may be appropriate in such systems, or for use with the methods of the invention. FIG. 4A illustrates an embodiment of a client. Client 400 includes mail and IM clients and a chat control module. Mail client 430 may be a typical mail client, useful with sendmail systems and other mail software for example. IM client 410 may be a typical instant messaging or peer-to-peer client, useful with one or more such systems. Chat control module 420 may be a module useful for monitoring mail client 430 to determine when successive email messages suggest switching to chat operation with IM client 410, and for logging such chats.

FIG. 4B illustrates an alternate embodiment of a client. Rather than providing an overall client as with client 400, a mail client 440 is provided. Integrated into mail client 440 is a chat control module 445, which monitors mail messages for email conversations which may benefit from chat operation. When peer-to-peer communication is desired, an integrated IM client 450 of mail client 440 is used to perform the communications.

Other embodiments of clients may also be useful. FIG. 4C illustrates another embodiment of a client. Chat wrapper 460 is a chat and email client which incorporates switching and monitoring modules as well. IM client 470 is provided for IM communications, both after switching from email or for communication originally initiated as IM. Mail client 490 is provided for email communication. Chat monitor module 485 is provided to monitor mail client 490 and determine if chat should be proposed to a user. Chat control module 480 is provided to propose chat to the user and to control IM client 470 so a log of the chat or summary can be provided after the chat ends.

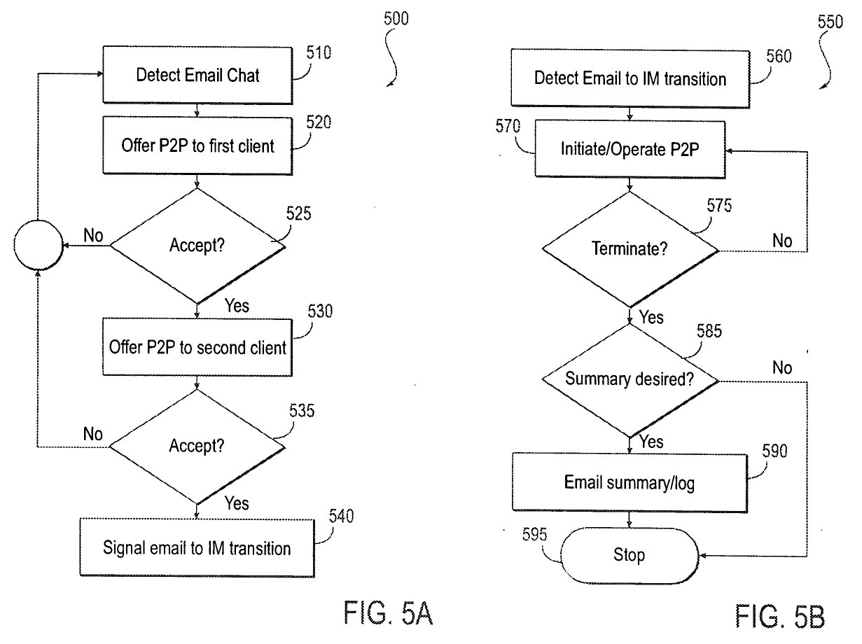

Various methods for detecting conversations and converting to chats may be used with the clients and systems discussed, and parts of one method may be used with other methods even though the features are not described in a single embodiment within this document. FIG. 5A illustrates an embodiment of a method of detecting an email conversation. Method 500 includes detecting a chat in email, offering peer-to-peer communication to both users, and signaling a transition to IM.

An email chat is detected at module 510. At module 520, the first client is offered the option to switch to peer-to-peer communication. Responsive to this query, the result is interpreted at module 525, if not accepted the process waits for another chat at module 510. If accepted, the process offers peer-to-peer communication to a second client. Again, a response to the query is interpreted at module 535, with a negative response resulting in a wait for the next opportunity at module 510. If the proposal is accepted by both clients (both users), then a signal is sent at module 540 to transition to IM or peer-to-peer communication.

Once a transition is indicated, a method of switching may be employed. FIG. 5B illustrates an embodiment of a method of switching from an email conversation to a chat. A signal to switch from email to IM communication is detected at module 560. At module 570, IM communication is initiated and operated by both clients. At module 575, a determination is made as to whether one or both participants have terminated the IM session. If not, module 570 continues to operate the IM communication. If termination has occurred, a determination is made at module 585 as to whether a summary is desired. This may occur through a query of one or both users, for example, and may require either one or both users to affirm a desire for a summary in various embodiments. At module 590, a summary is prepared if appropriate, and provided to the user(s). Regardless of use of the summary, the process terminates at module 595 (until invoked again).

Note that summaries have been discussed in various embodiments. A summary may be a summary provided by a user. A summary may also be a log of the chat or peer-to-peer communication (e.g. a verbatim copy). Moreover, a summary may be delivered as a file saved at the end of the communication, as an email to a participant or both participants, or as a document accessible at a location either set at delivery or predetermined for example.

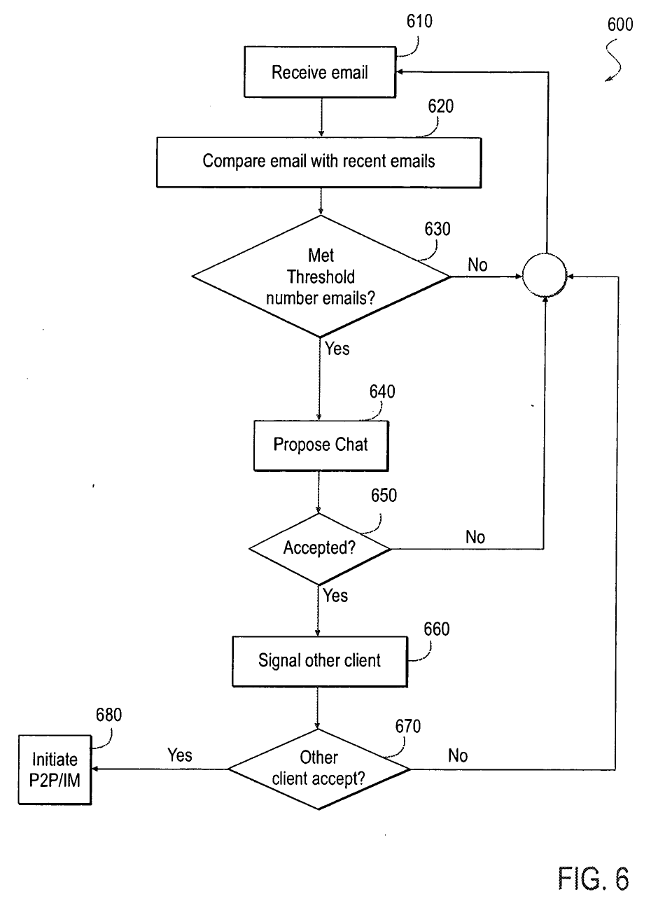

Detection has typically been discussed with respect to a time threshold, or without a threshold. Other thresholds may also be used. FIG. 6 illustrates another embodiment of a method of switching from email to chat operation. Method 600 includes receiving an email, comparing it to recent emails, determining a threshold number of emails has been met, proposing a chat, having the chat accepted, signaling the sender of the email, having the other client accept the chat, and initiating the chat.

At module 610, an email is received. At module 620, the email content is compared to recent emails received. This may effectively invoke a time threshold, either through a predetermined limitation of the comparison to emails received within a set amount of time, or through user deletion of emails. At module 630, a determination is made as to whether enough emails with related subject matter have been received (and/or sent). If not, the process waits for the next email at module 610.

If so, (threshold met), a chat is proposed (e.g. the user is queried) at module 640. At module 650, a determination is made as to whether the proposal was accepted. If not, the process returns to module 610. If so, a client for the other user involved in the related emails is signaled at module 660.

At module 670, a determination is made as to whether the client of the other user (and thus the other user) has accepted a switch to chat mode. If not, the process returns to module 610. If the client did accept, a chat or peer-to-peer communication is initiated at module 680. Initiation and maintenance of the peer-to-peer communication may be understood with reference to other methods discussed in this document.

Another feature which may be understood is the limitation to two people. While detection of chats between two people by email may be easiest, it may be useful to expand the chats to multiple participants, and may similarly be useful to offer this option to users, or to detect email chats among multiple users. Such expansion of the methods, systems and apparatus herein may be accomplished without undue experimentation.

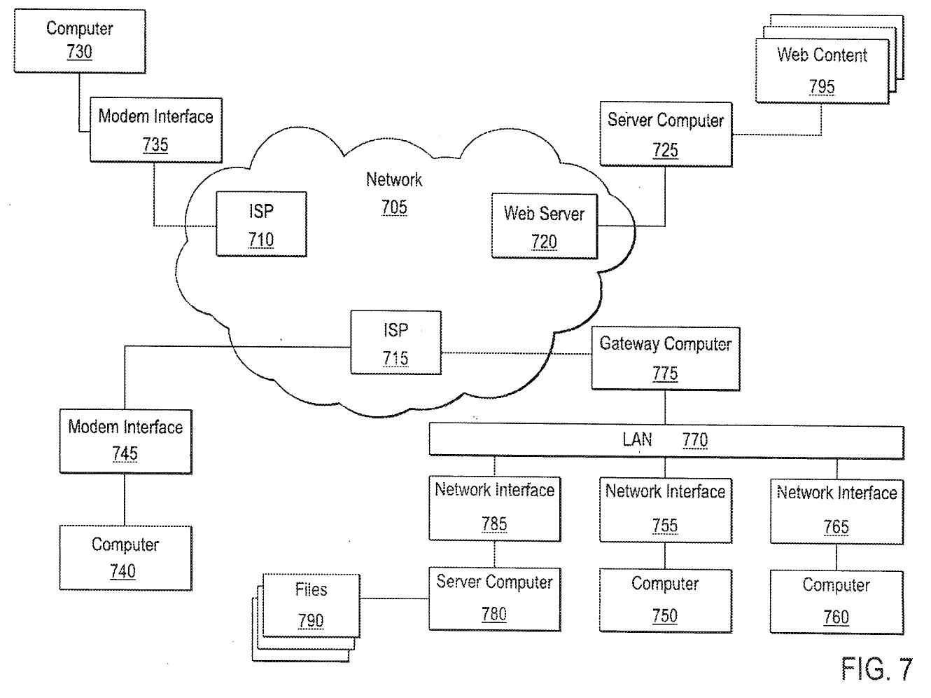

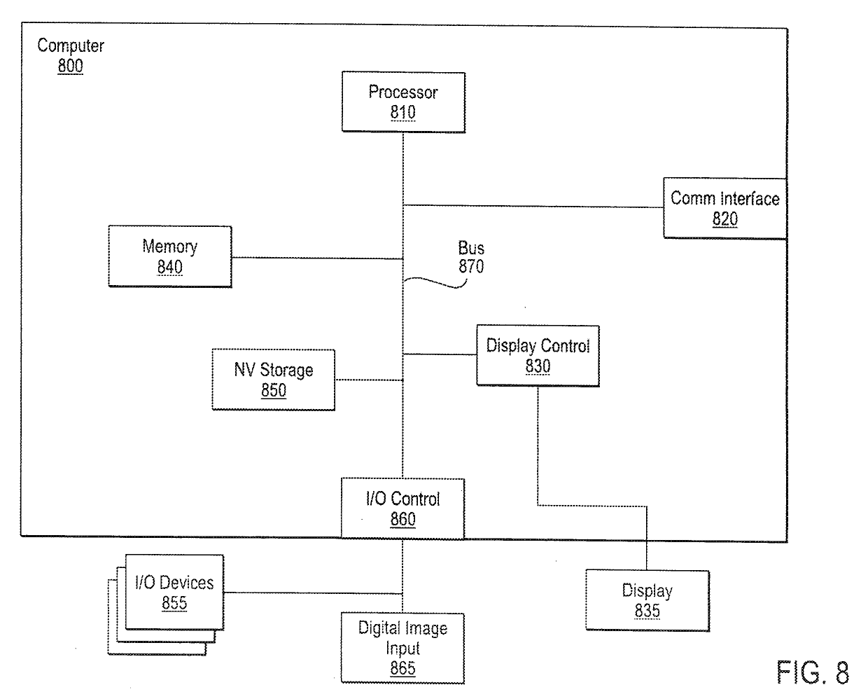

The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 740, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web-server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

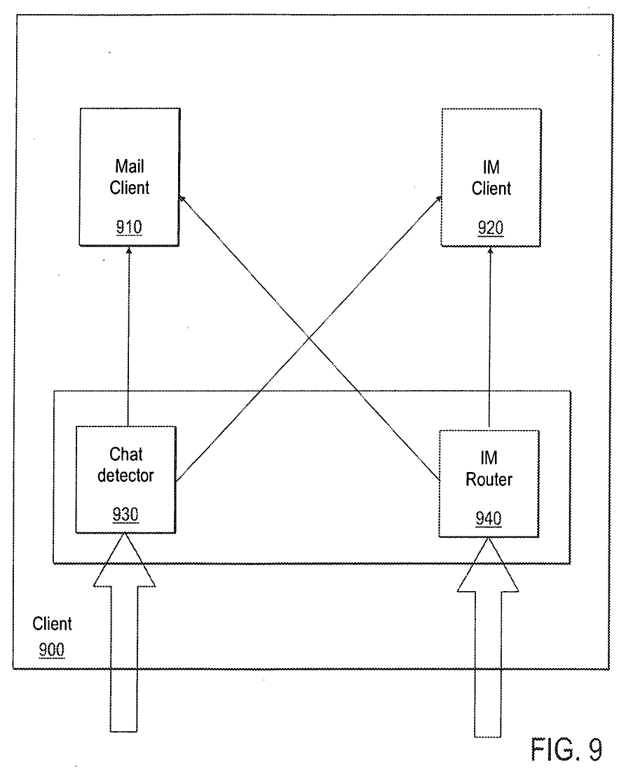

While various systems and methods have been discussed, one may expect various clients to be used with the embodiments thus described and other embodiments not specifically described. FIG. 9 illustrates another embodiment of a client. Client 900 is an email and IM client which allows for switching between the two communication modes. Data is received as either email or IM data. Email data is passed through chat detector 930 to determine whether email communications should be switched to chat communication. The email data is then sent on to a conventional (or relatively conventional) mail client 910. If a chat is accepted responsive to chat detector 930, it activates IM client 920 for IM communication. IM data is received by IM router 940 (an interface between IM client 920 and a network for example). If the IM session is terminated, IM router 940 may provide a summary or log to mail client 910 as an email for example. Otherwise, IM data is transferred to IM client 920 in a conventional manner.

One skilled in the art will appreciate that although specific examples and embodiments of the system and methods have been described for purposes of illustration, various modifications can be made without deviating from the spirit and scope of the present invention. For example, embodiments of the present invention may be applied to many different types of databases, systems and application programs. Moreover, features of one embodiment may be incorporated into other embodiments, even where those features are not described together in a single embodiment within the present document. Accordingly, the invention is described by the appended claims.

What is claimed is:

1. A method, comprising:
detecting related emails exceeding a predetermined threshold; and
initiating an instant message chat between senders of the emails.

2. The method of claim 1, further comprising:
querying a first sender of the related emails about whether to initiate the instant message chat.

3. The method of claim 2, further comprising:
querying a second sender of the related emails about whether to initiate the instant message chat.

4. The method of claim 1, wherein:
initiating the instant message chat includes querying a first sender of the related emails and a second sender of the related emails.

5. The method of claim 1, further comprising:
providing a log of the instant message chat.

6. The method of claim 5, further comprising:
querying a first sender of related emails as to whether the log is desired.

7. The method of claim 1, further comprising:
querying a first sender of the related emails as to whether a summary of the instant message chat is desired.

8. The method of claim 7, further comprising:
receiving a user summary from the first sender.

9. The method of claim 8, further comprising:
prompting the first sender to provide the user summary responsive to a user response to the querying for a summary.

10. The method of claim 1, wherein:
the method is performed by a processor executing a set of instructions, the set of instructions embodied in a machine-readable medium.

11. A system, comprising:
a processor;
a memory coupled to the processor;
a user interface coupled to the processor;
a network interface coupled to the processor;
a chat detector module coupled to the processor; and
an instant messaging module coupled to the processor.

12. The system of claim 11, further comprising:
means for querying a user to allow the user to request a summary.

13. The system of claim 11, further comprising:
an email server.

14. The system of claim 12, further comprising:
a first user computer; and
a second user computer.

15. A method, comprising:
detecting a series of related emails,
querying a first user to determine if the first user desires to switch to a chat;
querying a second user to determine if the second user desires to switch to a chat; and
initiating a chat between the first user and the second user.

16. The method of claim 15, further comprising:
querying the first user and the second user about providing a log of the chat between the first user and the second user.

17. The method of claim 16, further comprising:
providing the log of the chat between the first user and the second user.

18. The method of claim 15, further comprising:
querying the first user about whether a summary of the instant message chat is desired.

19. The method of claim 18, further comprising:
receiving a user summary from the first user.

20. The method of claim 19, further comprising:
prompting the first user to provide the user summary responsive to a user response to the querying for a summary.
